(19) United States
(12) Patent Application Publication
(10) Pub. No.: US 2001/0008191 A1
(43) Pub. Date: Jul. 19, 2001

(54) Electric power generation system for electric vehicles

(76) Inventors: Vincent A. Smith, Vallejo, CA (US); Larry J. Kinchen, Vallejo, CA (US); Susan V. Smith, Vallejo, CA (US)

Correspondence Address: HAROLD D. MESSNER, 1021 NEBRASKA ST., VALLEJO, CA, 94590, US

(21) Appl. No.: 09/759,831

(22) Filed: Jan. 12, 2001

Related U.S. Application Data
(63) Continuation-in-part of application No. 60/176,934, filed on Jan. 18, 2000.

(51) Int. Cl. B60K 6/00

(52) U.S. Cl. 180/65.3

(57) ABSTRACT

An electrical power generating system is described for generating electrical energy for an electric vehicle, via the motion of the non-drive wheels, which converts kinetic energy to electrical energy to replenish the batteries of said vehicle. The preferred version places one or more alternator/generator(s) at the non-driven wheels of the vehicle. Each alternator/generator is unitarily formed with respect to a mounting plate unitarily formed with respect to said mounting plate and said vehicle's suspension, and each alternator/generator includes a rotating field means integrated with the rotating mounting plate attached to the wheel and a stationary stator means stationarily attached to the frame through the suspension. Conventional electrical contact means attached to between said rotating field means and said stationary stator means for generating electrical current for said vehicle. Since the mechanical loading on the spindle bearing assemblies has been substantially increased, the bearing assemblies of the invention are of a heavy-duty design. That is, such bearing assemblies are large enough to handle the weight of said vehicle, including that of the alternator, as well as the weight of the wheel assembly, including tire and brakes. As the vehicle moves forward or backward, the rotational force applied to the vehicle's wheels will rotate the integrated rotating field means relative to the stationary stator means to produce alternating current (AC).

Alternating current is converted to direct current (DC) either by a diode bridge, transformer, or controller, for distribution to the EV's electrical system. DC electricity is used to recharge storage batteries, provide electricity for the drive motor and operate the vehicle's electrical equipment. Thus, the regenerative system, does not add any additional load on the drive motor. Wheel bearing assemblies are usually used for all wheels on vehicles and the very nature of bearing assemblies are to reduce friction. By the incorporation of alternators into the wheel bearing assemblies, a vehicle can generate electricity when moving, without additional workload to the drive train; since wheel bearing assemblies are a necessary and integral part of any rolling vehicle and by their very nature reduce friction and resistance.

### RELATED APPLICATION

This is a continuation-in-part of Ser. No. 60/176,934 filed Jan. 18, 2000 for “IN-LINE ELECTRIC POWER GENERATING SYSTEM FOR AN ELECTRIC VEHICLE” by Vincent A. Smith and Susan V. Smith.

### SCOPE OF THE INVENTION

This invention relates to an energy conversion system that can generate electricity for a rectilinearly moving vehicle, especially for an Electric Vehicle (hereinafter referred to as an “EV”). This system of the invention is characterized by having electric alternators or generators combine functions with wheel bearing assemblies to tap into the rotational energy of the wheels of such vehicle. These combination wheel bearing assemblies/alternators or generators are also referred to as “Regenerators”. The invention provides an efficient and cost-effective energy conversion system, which ensures a highly reliable supply of electricity from kinetic energy, intrinsic to a moving vehicle, such energy being heretofore wasted or untapped. Thus, the torque obtained by the rotating wheels of an E.V., in motion, will generate electricity to feed back into the electrical system to reduce electrical demands upon the E.V. batteries.

### BACKGROUND OF THE INVENTION

During the entire 20^{th} century and the beginning of the 21^{st} century, internal combustion engines have powered almost all mechanized transportation vehicles. Recently, electric vehicles (E.V.'s) have been gaining acceptance due to increasing fuel prices, declining stores of fossil fuels and worsening atmospheric conditions resulting from the burning of such fuels, I.E. Air Pollution and Global Warming. A roadworthy, freeway-capable EV will typically use between 16 and 24 batteries, which are wired together in series, to produce between 96 and 144 volts to power the electric motor of the EV. These batteries need to be periodically recharged after being driven for a maximum range of between 60 and 100 miles at typical top speeds of 60-80 mph.

At present, batteries can only be recharged at plug-in stationary sites where 110/220-line voltage, is available. In practice, an EV is usually recharged overnight during a 6 to 8 hour period. This finite amount of energy storage is the major drawback for EV s, resulting in limited range and slower speeds, especially in comparison with gasoline-powered vehicles.

The energy conversion to electric current by the Regenerators will affected by;

the friction of tires against the road and the resistance of the road surface;

the weight of the vehicle; the environment The EV is operating in, I.E., temperature and humidity;

the terrain the EV is operating in, smooth, rough, mountainous, etc;

the resistance of the wheel bearings;

the resistance of wind against the EV;

the resistance of the motor bearings and drive train;

the electrical resistance of conductive wires.

The amount of electricity generated by the use of Regenerators can become significant by using multiple regenerators (2 or more) to generate power for cycling back into the E.V.'s electrical system. An EV traveling at 60 MPH would have an electric motor rotating at approximately 2000 RPM, the wheels contacting the road will rotate at approximately 1200 RPM, this will cause the Regenerators to rotate at approximately 1200 RPM to generate electric current.

### BACKGROUND—A DESCRIPTION OF PRIOR ART

Scott et al. U.S. Pat. No. 4,377,975, describes an alternator that is mounted on the outside of the axle of a railroad car to produce electricity. This patent is specific to railroad cars, as the attachments to the axle are not adaptable to other vehicles. This is an attachable device, not designed to be an integral part of a vehicle.

Boyer, U.S. Pat. No. 4,539,497 and U.S. Pat. No. 4,536,668, describes a wheel hub mountable, pendulum-type generator, which attaches to the wheels of vehicle to generate electric power for either a tire pressure monitoring system or to provide power to a fluid pressure monitoring system, respectively. This is an attachable device that is not an intrinsic part of the vehicle. The pendulum design of the generator is of a low voltage producing type. This device would be suitable for powering low voltage sensors as described by the inventor, but these generators would unsuitable to recharge or power an E.V.'s electrical system.

Fisher U.S. Pat. No. 5,004,944, and U.S. Pat. No. 5,311,092, describe electromagnetic transducers that work as a motor, alternator, or generator. They are described as a high output, high speed and low weight transducers with self-propelled vehicle applications, such as passenger cars. They do not claim to perform the function of wheel bearings, and they are be mounted at each wheel, adjacent to an axle, with drive being preferably achieved through a gear reduction mechanism which communicates to the drive train indirectly, as opposed to being intrinsic to the drive train as a wheel bearing would be. By the transducer's design, it cannot perform the functions of motor, alternator, or generator simultaneously, which means that this system will place a load on the drive train when employed in a generator or alternator capacity. This characteristic would be classified as regenerative braking.

Schlutter et al. U.S. Pat. No. 5,079,461, describes a disc shaped armature with permanent magnets, rotating in the hub of a bicycle wheel. This electric generator is specific to bicycles and is of a low voltage design.

Schlutter et al. U.S. Pat. No. 5,294,853, describes an electric drive motor for an electric vehicle. The motor comprises at least one three-phase brush-less, disk rotor motor assigned to one vehicle wheel. This patent does not claim to generate electricity or to perform the function of a wheel bearing.

Couture et al. U.S. Pat. No. 5,327,034, describes an electrically powered, outer-rotor type, wheel-motor assembly. This assembly performs the function of drive motor and wheel bearing. This system does not claim to be an electric alternator or generator.

Lahos U.S. Pat. No. 5,584,561 describes a bicycle lighting system with a magnet mounted to a housing on one of the wheels to generate low voltage electricity for bicycle lights. This electric generator is specific to bicycles and is of a low voltage design.

Shepherd et al. U.S. Pat. No. 5,753,987, describes a railway car and an axle driven electrical generator assembly to provide electrical power to electrically operable railroad car brakes.

Damron U.S. Pat. No. 5,920,127 describes using a windmill electric generator mounted on an EV to convert wind energy into electricity. The windmill concept is a proven technology on land, but the addition of a windmill system to an EV will increase drag and affect the efficiency of the EV. Since the very nature of a windmill propeller is to redirect wind forces to provide rotation to the propeller (thus, increasing air resistance) and the body of the generator itself will affect the aerodynamics of the vehicle. There is also “down-time” for the windmill generators, such as when the EV is traveling at slow speeds, or during vehicle acceleration and deceleration. This “down-time” results in electricity expended and none generated, resulting in an inefficient system of replenishing energy stores.

Mula Jr. U.S. Pat. No. 5,986,429, and Ibaraki ET AL, U.S. Pat. No. 6,003,626 describe regenerative braking systems. In this method, a switch is thrown on the controller of the electric motor to make it perform in the manner of a generator. In the electric motor mode, electricity is used to create kinetic energy, whereas in the generator mode, kinetic energy is used to create electricity, this causes braking and slowing of the vehicle by placing a load on the drive train. While this method can be effective, it only provides short bursts of generated electricity when braking and cannot be used to create electricity continuously, due to the fact that the motor/generator works either as a motor or a generator, but cannot do both functions at the same time. Therefore, this system is inefficient at producing electricity, since only a small portion of a vehicle's kinetic energy can be recovered only at certain specific times.

Takamiya et al, U.S. Pat. No. 5,115,159 and Hill, U.S. Pat. No. 6,037,690, both describe built in generators for the hub of a bicycle. These low voltage generators would be intrinsic to the body of the bicycle and would be suitable to power the accessories of a bicycle only. They are designed specifically for bicycles, each having a central spindle and a low voltage design, neither of these designs is suitable to recharge or power an E.V.'s electrical system.

### OBJECTS AND ADVANTAGES

It is therefore an object of this invention is to provide electrical vehicles with a practical, improved and efficient system of providing electrical energy to the vehicle's batteries while the vehicle is in motion.

It is still another object of this invention to provide an energy recovery/regenerating system, converting wasted or untapped kinetic energies of a vehicle's wheels into electricity via the direct connection of the vehicle's wheel(s) to a generator or alternator.

It is still another object of this invention to increase the maximum speed capabilities of an EV. Higher speeds demand a more rapid depletion of electricity stored in the vehicle's batteries, and this would adversely impact the range of a conventional EV. An EV employing the Regenerative system will create more electricity available to power the EV's motor, by the conversion of the untapped kinetic energies of the wheel bearings into electricity. The creation of surplus electricity by the Regenerative system thus allows the EV user to drive at top speeds for longer durations.

It is still another object of this invention to, increase the operating range of an EV by decreasing the weight of an EV employing the regenerative system. This is accomplished in two ways:

1. By adding the electricity generated from the Regenerators to an E.V.'s electrical system for distribution to the drive motor and decreasing dependence upon battery charge. Traditionally, all electric vehicles have been dependent upon finite stores of electricity in batteries. The range of the vehicle was dictated by when the charge was depleted. The electricity generated by a vehicle using the Regenerator system however, will increase range by adding power to the drive motor in addition to the charge already available in the batteries.

2. By decreasing the need for batteries, an EV employing the Regenerator system will be able pare down the total number of batteries necessary for operation, as opposed to the battery requirement of a traditionally designed EV. Battery charge will be required to put the vehicle in motion. Once in motion, the regenerators will be able to contribute electricity to the electrical system for recharging batteries, running the drive motor, powering accessories, etc. Batteries generally weigh 40 lbs. or more and excessive vehicle weight is a limiting factor in terms of EV range and performance. As an application of Newton's Third Law, a lighter vehicle will take less energy to put it into motion, or in this instance, less electricity. By employing the Regenerator system in an EV, one can expect to gain greater vehicle range by; increasing the amount of electricity available to power the EV; and decreasing vehicle weight by eliminating a number of batteries.

It is still another object of this invention to increase the payload of electric vehicles by decreasing dependence upon batteries, thus decreasing the need for carrying as many batteries. Since batteries are generally bulky, conventional E.V.'s take up space for battery storage that is usually used for passenger or cargo room. An EV employing the Regenerator system will have increased payload capacity by decreasing the number of batteries necessary for motion and thus, said EV would have greater cargo and passenger room than a conventional EV.

With these and other objects in view, which will become apparent to one skilled in the art as the description proceeds, this invention resides in the novel construction, combination, and arrangement of parts substantially as hereinafter described, and more particularly defined by the appended claims, it being understood that changes in the precise embodiments of the herein disclosed invention are meant to be included as come within the scope of the claims.

Further objects and advantages of the regenerative system will become apparent from consideration of drawings and the ensuing description of the device.

### SUMMARY

An electrical power generating system is described for generating electrical energy for an electric vehicle, via the motion of the non-drive wheels, which converts kinetic energy to electrical energy to replenish the batteries of said vehicle. The preferred version places one or more alternator/generator(s) at the non-driven wheels of the vehicle. Each alternator/generator is unitarily formed with respect to a mounting plate unitarily formed with respect to said mounting plate and said vehicle's suspension, and each alternator/generator includes a rotating field means integrated with the rotating mounting plate attached to the wheel and a stationary stator means stationarily attached to the frame through the suspension. Conventional electrical contact means attached to between said rotating field means and said stationary stator means for generating electrical current for said vehicle. Since the mechanical loading on the spindle bearing assemblies has been substantially increased, the bearing assemblies of the invention are of a heavy-duty design. That is, such bearing assemblies are large enough to handle the weight of said vehicle, including that of the alternator, as well as the weight of the wheel assembly, including tire and brakes. As the vehicle moves forward or backward, the rotational force applied to the vehicle's wheels will rotate the integrated rotating field means relative to the stationary stator means to produce alternating current (AC).

Alternating current is converted to direct current (DC) either by a diode bridge, transformer, or controller, for distribution to the EV's electrical system. DC electricity is used to recharge storage batteries, provide electricity for the drive motor and operate the vehicle's electrical equipment. Thus, the regenerative system, does not add any additional load on the drive motor. Wheel bearing assemblies are usually used for all wheels on vehicles and the very nature of bearing assemblies are to reduce friction. By the incorporation of alternators into the wheel bearing assemblies, a vehicle can generate electricity when moving, without additional workload to the drive train; since wheel bearing assemblies are a necessary and integral part of any rolling vehicle and by their very nature reduce friction and resistance.

The preferred embodiment of the Regenerator design uses a brush-less, permanent magnet alternator in which the cylindrical, hollow, rotating field means, supported by bearings on either end of the shaft, is free to rotate about the spindle of an axle. The rotor assembly is then completed by the surrounding stator means of the conversion system, which is stationary and fixed to a housing bolted to the suspension. The entire assembly is sealed, and finally encased in a protective cooling jacket housing.

The preferred embodiment for a vehicle using this system has one, two, or more Regenerators built in to axles of an electric vehicle. The alternator(s) would be integrated into and share the bearing assemblies of the non drive train wheels. As the vehicle moves forward, the rotational force applied to the vehicle's wheels will rotate the integrated rotor inside the stator to produce alternating current (AC). Alternating current is converted to direct current (DC) either by a diode bridge, transformer, or controller for distribution to the E.V.'s electrical system. DC current will then be used to recharge storage batteries, provide electricity for the drive motor and operate the vehicle's electrical equipment. For automotive applications, the regenerators will need to be sealed, especially in a wet environment where submersion could either short out, or eventually corrode the Regenerators. Sealing the Regenerators will also protect the internal mechanism from abrasive grit, dirt and chemicals. Once the Regenerator is sealed however, a cooling system must be used with either a fluid, gas or air coolant.

Since the preferred embodiment would combine an alternator with a wheel bearing assembly and carry out the function of a wheel bearing assembly, it may be possible to use the Regenerator on any and all wheels, drive or non-drive, to increase electrical energies of said vehicle.

### OPERATION

In the regenerative system, an electric motor ultimately and indirectly, turns a generator to generate electricity for its own use. This is done by using stored electricity from batteries to run the electric motor that runs a transmission, to turn the rest of the drive train, which rotates the wheels and wheel bearing assemblies, to put the EV into motion. This motion turns the in-line alternators/wheel bearing assemblies (regenerators), which generates electricity that is reintroduced to the vehicle's electrical system.

### BRIEF DESCRIPTION OF DRAWINGS

FIG. 1 is a section taken along an axle of common vehicle illustrating a first embodiment of the invention, viz., a permanent magnet, brush-less alternator/generator version.

FIG. 2 is a section taken along an axle of common vehicle illustrating a first embodiment of the invention, viz., a cylindrically wire wound alternator/generator version.

FIG. 3 is a schematic, showing various elements of the invention in block form and a front wheel drive electric vehicle employing Regenerators on non-drive train rear wheels.

FIG. 4 is a detail of the protective cooling jacket housing for the embodiments of FIGS. 1 and 2.

### DETAILED DESCRIPTION OF EMBODIMENTS

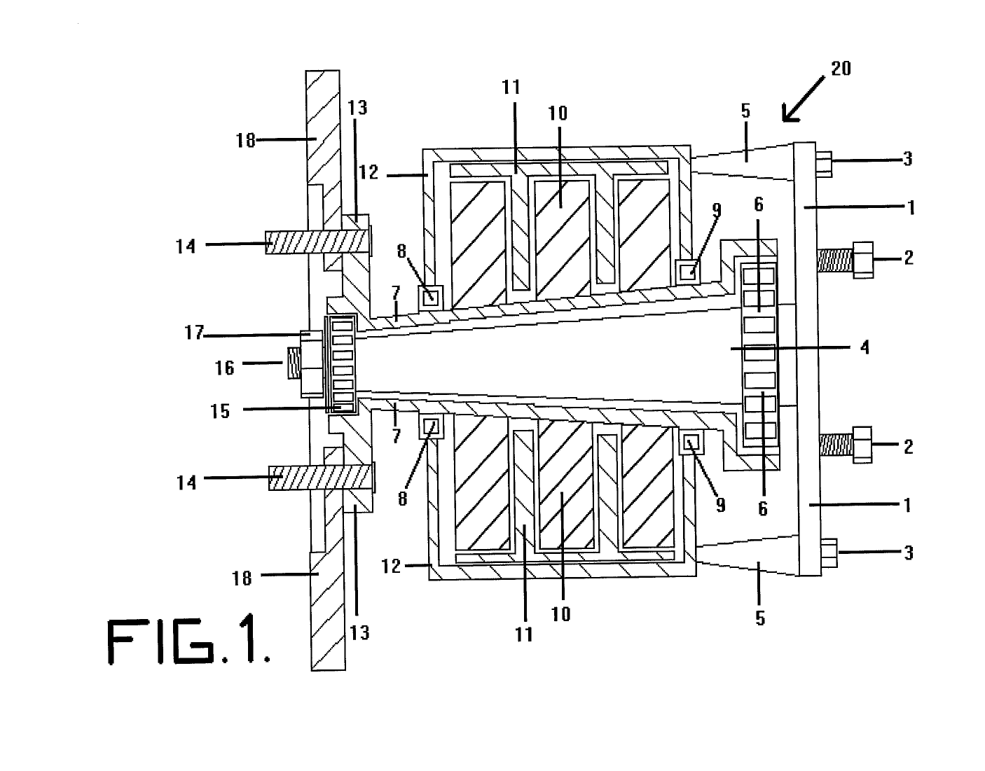

FIG. 1 is a section taken along an axle of common vehicle illustrating a first embodiment of the invention, viz., a permanent magnet, brush-less alternator/generator version; Regenerator 20. The backing plate/ mounting plate 1 is bolted to a vehicle frame via a suspension (both not shown) and mounting bolts 2. The spindle 4 of the wheel bearing assembly is integrated with the mounting plate 1. The spindle 4 has two bearing assemblies 6 and 15 that support and allow the hollow cylindrical rotor 7 to rotate around the spindle 4. The distal end of the spindle 16, distal to the vehicle frame, has been necked down and threaded to allow attachment of a bearing assembly 15, and retaining nut 17. The rotor 7 has permanent magnets 10 attached to it for generating a rotating magnetic field. The rotor 7 has a mounting plate 13 that allows the placement of lug bolts 14, to which a vehicle's tires may be mounted. There is a disk 18 of a disk brake assembly that fits over the lug bolts 14, on the mounting plate 13. The rotor 7 and permanent magnet array 10, are enclosed by a protective cover/stator housing 12, that supports the stator 11. There are bearing seals 8 and 9 that serve to seal the inner workings of the regenerator 20 from the elements and dirt. The bearing seals 8 and 9 also allow the rotor 7 to spin freely inside the stator housing 12. The stator housing 12, is supported by the stator housing supports 5, which have a bolt 3 passing through to attach the mounting plate 1. This drawing does not show the complete workings of an operating alternator/generator. For example, it is obvious to anyone skilled in the art, that electrical wiring and electrical contacts have been omitted.

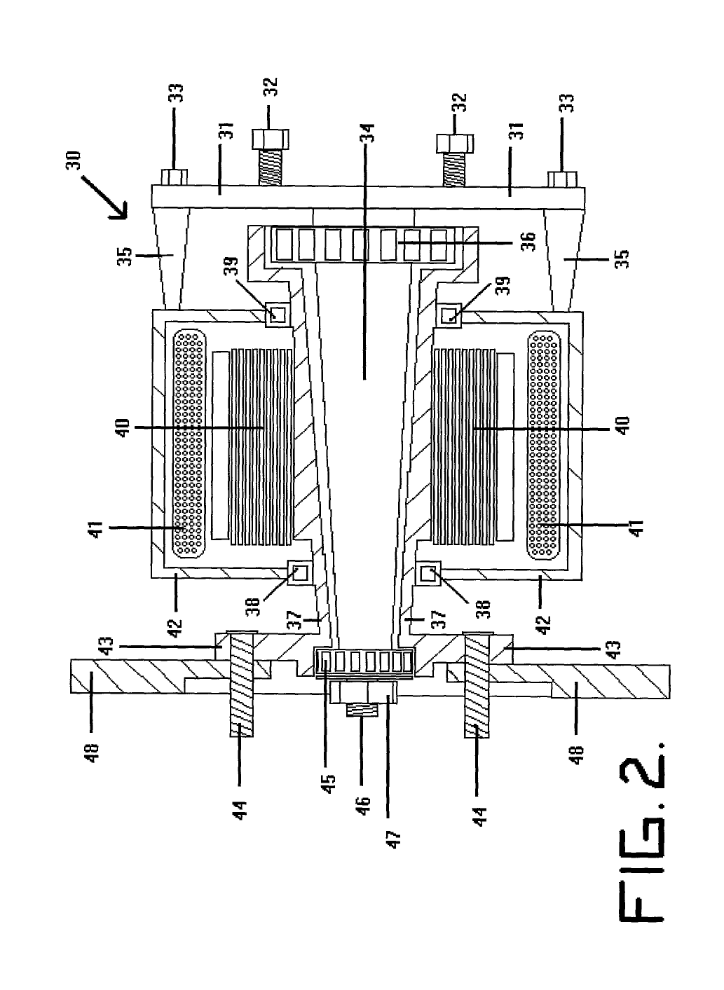

FIG. 2 is a section taken along an axle of common vehicle illustrating a first embodiment of the invention, viz., a cylindrically wire wound alternator/generator version; Regenerator 30. The backing plate/mounting plate 31 is bolted to a vehicle suspension via the mounting bolts 32. The spindle 34 of the wheel bearing is integrated with the mounting plate 31. The spindle 34 has two bearings 36 and 45, which support and allow the hollow cylindrical rotor 37 and secondary rotor windings 40, to rotate around the spindle 34. The distal end of the spindle 46, distal to the vehicle frame, has been necked down and threaded to allow attachment of a bearing assembly 45, and retaining nut 47. The rotor shaft 37 has metal plates and secondary wire windings 40 attached to it for the generation of an electric field. The rotor has a mounting plate 43 that allows for the placement of lug bolts 44, to which a vehicle's tires may be mounted. There is a disk 48 of a disk brake assembly that fits over the lug bolts 44, on the mounting plate 43. The rotor 37 and the secondary conventionally wire-wound rotor 40, are enclosed by a protective cover/stator housing 42, that supports the stator windings 41. There are bearing seals 38 and 39 that serve to seal the inner workings of the regenerator 30 from the elements and dirt. The bearing seals 38 and 39 also allow the rotor shaft 37 and secondary windings 40 to spin freely inside the stator housing 42. The stator housing 42 is supported by the stator housing supports 35, which have bolts 33, passing through to attach the mounting plate 31. This drawing does not show the complete workings of an operating alternator. For Example, it is obvious to anyone skilled in the art, that electrical contacts and connecting wires have been omitted.

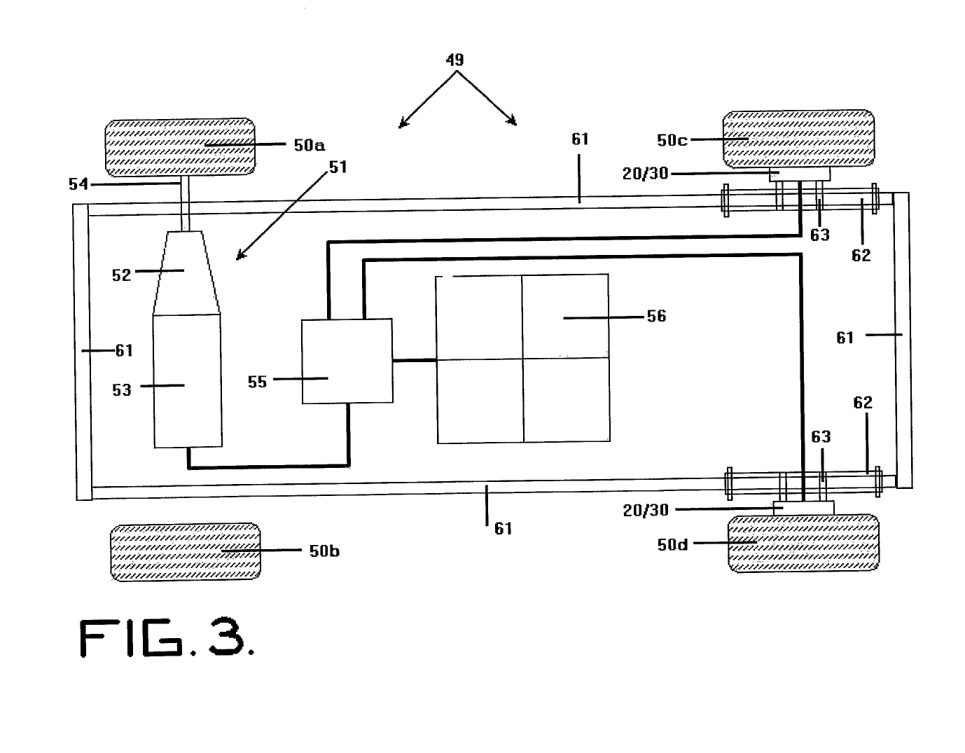

FIG. 3 is a schematic, showing various elements of the invention in block form and electric vehicle 49 employing Regenerators 20 and 30. There are a series of tires 50A, 50B, 50C, 50D. Tire 50a is connected to the drive train 51, via a connection to the drive axle 54. The drive axle 54 attaches to the transmission 52, which in turn, is mated to the electric drive motor 53. Power is supplied to drive motor 53 by the electric controller system 55, will put the vehicle 49 in motion. The controller 55 switches and controls the power for drive motor 53, which is derived from the power pack of storage batteries 56, or from the regenerators 20 or 30 that are attached to tires 50C and 50D. The Regenerators 20 or 30 will tap into and convert the kinetic energy of non-drive wheels, 50C and 50D, while the vehicle 49 is in motion. The controller system 55 will also distribute electricity for storage to the batteries of the power pack 56. This drawing does not show the complete workings of an operating EV. For Example, it is obvious to anyone skilled in the art, that the Regenerators are attached to a suspension system, only partially illustrated by mounting bolts 63 and leaf springs 62 of a suspension system assembly, which is attached to the frame 61 of the EV 49.

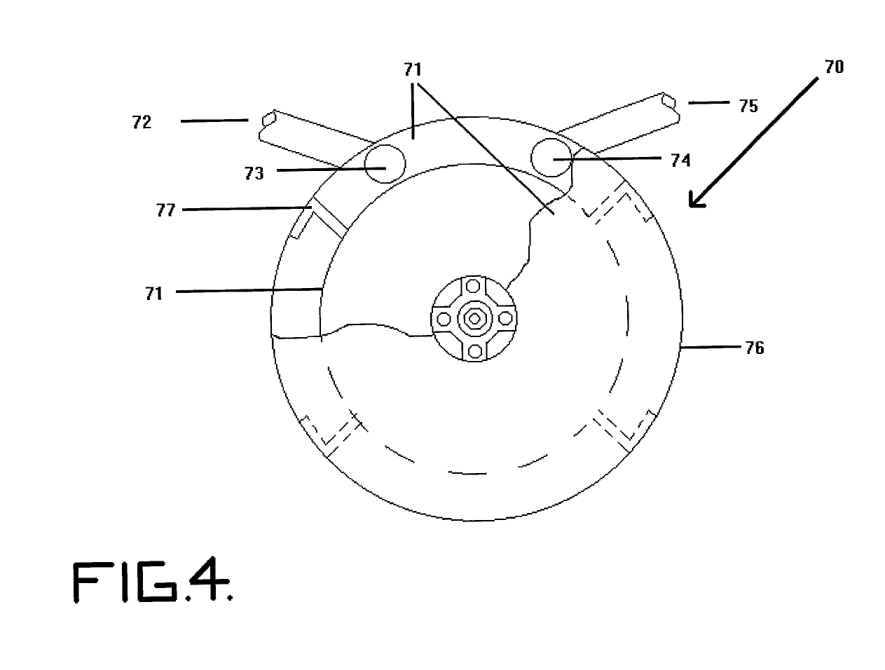

FIG. 4 is a detail of the protective cooling jacket housing, indicated by arrow 70, for the embodiments of FIGS., 1 and 2, partially in section and attached to the outer circumferential surface 71 of Regenerator 20, 30 of FIGS. 1-3 to permit cool air or any other coolant to enter housing 70 at intake vent 73 via air duct 72, and exiting by exit opening 74 to be removed by exhaust duct 75 to cool the aforementioned Regenerator 20, 30 of FIGS. 1-3. The housing 70 is cylindrical in cross section and includes pairs of end walls 71 attached to the ends of the cylindrical housing 76. A series of L-shaped mounting brackets 77 attach to the cylindrical housing 76, relative to the circumferential surface 71 of the Regenerator 20, 30.

With reference to FIGS. 3 and 4, note that the controller system 55 is used as a function of the speed of vehicle 49 to rotation of the rotor 7 to provide for controlled switching of the power generated by the regenerators 20 and 30 within the following ranges:

### CONCLUSIONS, RAMIFICATIONS AND SCOPE

By extending the range and decreasing the recharge times of EV s, EV s become more attractive to a public accustomed to the convenience and range of gasoline-powered engines. DAMRON U.S. Pat. No. 5,920,127, reports a 40% increase in range while using a propeller driven alternator on the roof of a car. This increase in range was obtained despite the worsening the aerodynamics of the vehicle and the inefficient and indirect generation of electricity. With the regenerative system, using two or more alternators incorporated into the wheel bearings (Regenerators) on line with the charging system and not disrupting vehicle aerodynamics or increasing workload, one may expect at very least, an 80% or more increase in range.

Assuming a wheel diameter of 16 inches, the relationship between the speed of the vehicle 49 and rotation of the rotor 7 is as shown below.

2520 RPM at 120 MPH
2100 RPM at 100 MPH
1680 RPM at 80 MPH
1260 RPM at 60 MPH
630 RPM at 30 MPH
525 RPM at 25 MPH
420 RPM at 20 MPH
210 RPM at 10 MPH

In this regard a range of rotor rotation to power transfer as provided by controller system 55 should be as follows: a broad range of 210 to 2520 RPM and a preferred range of 525 to 2100 RPM.

Although the description above contains many specificities, these should not be construed as limiting the scope of the invention but as merely providing illustrations of some of the presently preferred embodiments of the invention. For example, although electric automobiles were mentioned extensively, the regenerative system would work on most electric vehicles with a side-mounted spindle, from toy cars for children, to golf carts, motorcycles, and industrial vehicles. Other variations would be that, the Regenerators may be used on any and all wheels of a given vehicle, it can be used in an alternator or generator configuration, it can be constructed in a brush-less permanent magnet configuration, or use windings and brushes in a conventional design. It may be sealed and use a cooling system, or be open to air. Thus, the scope of the invention should be determined by the appended claims and their legal equivalents, rather than by the examples given.

What is claimed is:

1. In an energy conversion system for a motor vehicle having a frame, a driving motor attached to said frame for driving one pair of front wheels. Attached to said frame, are a pair of non-driven rear wheels. Said non-driven wheels includes a pair of wheel bearing assemblies each attached across said frame opposite each other through a suspension and including stationary wheel bearing assemblies, supporting a stationary spindle and a rotatable mounting plate to which a non-driven wheel, brake rotor and tire are attached, the improvement comprising one or more alternator/generator(s) unitarily formed with respect to said mounting plate and said suspension, each alternator/generator including a rotating field means integrated with said rotating mounting plate and stationary stator means attached to said frame through said suspension and electrical contact means attached between said rotating field means and said stationary stator means for generating electrical current for said vehicle.

2. The improvement in accordance with claim 1., in which rotor means unitarily formed with respect to said mounting plate converts kinetic energy provided by rotation of said non-driven wheels into electric energy.

3. The improvement in accordance with claim 1., wherein the rotation of said non-driven wheels will produce, in the case of an alternator, alternating current (AC), or in the case of a generator, direct current (DC).

4. The improvement in accordance with claim 1., wherein the said rotor means includes a hollow shaft, supported by wheel bearing assemblies, that is free to rotate about a spindle of a wheel assembly of a vehicle.

5. The improvement in accordance with claim 1., wherein the electric energy converter is designed as a unit that encloses and attaches around a spindle of a wheel assembly of a vehicle.

6. The improvement in accordance with claim 1., that performs the function of a wheel bearing assembly, as the alternators would have two bearings respectively associated with the alternator walls and respectively mounted on both sides of said shaft so that the rotor can be rotated with respect to the stator casing, spinning freely on a spindle of said vehicle.

7. The improvement in accordance with claim 1., capable of generating electricity to power the electrical and electronic accessories of a vehicle, with current being routed by a controller.

8. The improvement in accordance with claim 1., capable of providing electricity to recharge the power pack (vehicle batteries), with electrical current being routed by a controller.

9. The improvement in accordance with claim 1., capable of providing electricity to the drive motor, with current being routed by a controller.

10. The improvement in accordance with claim 1., that can be configured using a conventional, wire-wound alternator or generator design.

11. The improvement in accordance with claim 1., that can be configured using a high-output, permanent magnet rotor and stator design.

12. The improvement in accordance with claim 1., which does not add any additional load on the drive motor. Wheel bearing assemblies are usually used on all wheels of a wheeled vehicle and the very nature of wheel bearing assemblies are to reduce friction and allow for movement of the vehicle. By the integration of alternators or generators into the wheel bearing assemblies, which are attached to the suspension of vehicle, a vehicle can generate electricity when moving, without additional workload to the drive train; since wheel bearing assemblies are a necessary and integral part of any modern rolling vehicle and by their very nature reduce friction and resistance.
